(19) United States
(12) Patent Application Publication
(10) Pub. No.: US 2016/0328995 A1
(43) Pub. Date: Nov. 10, 2016

(54) APPARATUS AND METHOD FOR A VISUAL GRAPHICAL DISPLAY OF HEALTH QUALITY ON AN ITEM OF FOOD PACKAGING

(71) Applicant: Tara Chand Singhal, Torrance, CA (US)

(72) Inventor: Tara Chand Singhal, Torrance, CA (US)

(21) Appl. No.: 15/133,234

(22) Filed: Apr. 20, 2016

Related U.S. Application Data
(60) Provisional application No. 62/157,305, filed on May 5, 2015.

(51) Int. Cl. G09B 19/00; B65D 85/34; B65D 63/10

(52) U.S. Cl. CPC G09B 19/0092; B65D 63/10; B65D 85/34

(57) ABSTRACT

A visual display of a graph on a packaging of a food item is displayed as guidance to the public of the health quality of the food item. The graph shows a rise of blood glucose level over a two hour time period from the consumption of the food item in a healthy adult as an indicator of a health quality of the food item.

### CROSS REFERENCE

This application claims priority from Provisional Application Ser. No. 62/157,305, filed on May 5, 2015 of Tara Chand Singhal, for Apparatus and Method for a Health Quality Indicator Visual Display on a Package or Food Item. The contents of application No. 62/157,305 are incorporated herein by reference.

### FIELD OF THE INVENTION

A visual display of a graph on a packaging of a food item is displayed as guidance to the public of the health quality of the food item. The graph shows a rise of blood glucose level over a two hour time period from the consumption of a food item as an indicator of a health quality of the food item.

### BACKGROUND

Now-a-days, based on the life style of people, specifically in the last so many decades, a large number of packaged food items, as a convenience to the public, are sold to them online as well as in retail stores by many food item manufacturers.

People in general, specifically in the last few decades or so have also become health conscious and have a desire to know what is in the food items they buy at stores. Therefore, these packages tell the buying public about the food item including different ingredients in the food item.

In the last few decade or, realizing that the food people buy and consume, has a direct affect on the health of people, US government has regulated display of additional nutritional information on the food packages.

For the most part, the foods that are sold as packaged items have undergone different degrees and phases of processing to make them suitable for packaging, large shelf life, as well as make them appeal to the buying public.

Unfortunately, in the last few decades or so, type 2 diabetes disease has become very prevalent and a large and a growing number of people are being diagnosed as diabetic or pre-diabetic. The underlying cause of diabetes is not known, and it is believed that there are multiple factors, including consuming packaged food items that are processed and highly processed, as well as sedentary life style.

The existing nutritional information on the packaged food items, while displaying basic nutritional information such as calories, carbohydrates, fiber and protein among other information is insufficient to indicate an over all health quality of the food item.

Others have created, around the year 1985, a measure called Glycemic Index (GI). GI is a scaled number and is derived from computing the area under the curve over a two hour period indicating an average rise of glucose in a group of ten healthy adults. Thus, GI acts also as an indicator of the total quantity of carbohydrates in the food. The following information on glycemic index, for the benefit of the reader is reproduced from Wikipedia.

The glycemic index or glycaemic index (GI) is a number associated with a particular type of food that indicates the food's effect on a person's blood glucose (also called blood sugar) level. The number typically ranges between 50 and 100, where 100 represents the standard, an equivalent amount of pure glucose.

The GI represents the total rise in a person's blood sugar level following consumption of the food; it may or may not represent the rapidity of the rise in blood sugar. The steepness of the rise can be influenced by a number of other factors, such as the quantity of fat eaten with the food. The GI is useful for understanding how the body breaks down carbohydrates and only takes into account the available carbohydrate (total carbohydrate minus fiber) in a food. Although the food may contain fats and other components that contribute to the total rise in blood sugar, these effects are not reflected in the GI.

The glycemic index is usually applied in the context of the quantity of the food and the amount of carbohydrate in the food that is actually consumed. A related measure, the glycemic load (GL), factors this in by multiplying the glycemic index of the food in question by the carbohydrate content of the actual serving. Watermelon has a high glycemic index, but a low glycemic load for the quantity typically consumed. Fructose, by contrast, has a low glycemic index, but can have a high glycemic load if a large quantity is consumed.

GI tables are available that list many types of foods and their GIs. Some tables also include the serving size and the glycemic load of the food per serving.

See Prior Art FIG. 7 that illustrates a Graph describing the rise of blood sugar after meals.

A practical limitation of the glycemic index is that it does not measure insulin production due to rises in blood sugar. As a result, two foods could have the same glycemic index, but produce different amounts of insulin. Likewise, two foods could have the same glycemic load, but cause different insulin responses. Furthermore, both the glycemic index and glycemic load measurements are defined by the carbohydrate content of food. For example, when eating steak which has no carbohydrate content, but provides a high protein intake, up to 50% of that protein can be converted to glucose, when there is little to no carbohydrate consumed with it. But because it contains no carbohydrate itself, steak cannot have a glycemic index. For some food comparisons, the “insulin index” may be more useful.

Glycemic index charts often give only one value per food, but variations are possible due to variety, ripeness (riper fruits contain more sugars increasing GI), cooking methods (the more cooked, or over cooked, a food the more its cellular structure is broken with a tendency for it to digest quickly and raise GI more), processing (e.g., flour has a higher GI than the whole grain from which it is ground as grinding breaks the grain's protective layers) and the length of storage. Potatoes are a notable example, ranging from moderate to very high GI even within the same variety.

The glycemic response is different from one person to another, and also in the same person from day to day, depending on blood glucose levels, insulin resistance, and other factors.

Most of the values on the glycemic index do not show the impact on glucose levels after two hours. Some people with diabetes may have elevated levels after four hours.

### Determining the GI of a Food

Foods with carbohydrates that break down quickly during digestion and release glucose rapidly into the bloodstream tend to have a high GI; foods with carbohydrates that break down more slowly, releasing glucose more gradually into the bloodstream, tend to have a low GI. The concept was developed by Dr. David J. Jenkins and colleagues in 1980-1981 at the University of Toronto in their research to find out which foods were best for people with diabetes. A lower glycemic index suggests slower rates of digestion and absorption of the foods' carbohydrates and may also indicate greater extraction from the liver and periphery of the products of carbohydrate digestion. A lower glycemic response usually equates to a lower insulin demand but not always, and may improve long-term blood glucose control and blood lipids. The insulin index is also useful for providing a direct measure of the insulin response to a food.

The glycemic index of a food is defined as the incremental area under the two-hour blood glucose response curve (AUC) following a 12-hour fast and ingestion of a food with a certain quantity of available carbohydrate (usually 50 g). The AUC of the test food is divided by the AUC of the standard (either glucose or white bread, giving two different definitions) and multiplied by 100. The average GI value is calculated from data collected in 10 human subjects. Both the standard and test food must contain an equal amount of available carbohydrate. The result gives a relative ranking for each tested food.

The current validated methods use glucose as the reference food, giving it a glycemic index value of 100 by definition. This has the advantages of being universal and producing maximum GI values of approximately 100. White bread can also be used as a reference food, giving a different set of GI values (if white bread=100, then glucose ≈140). For people whose staple carbohydrate source is white bread, this has the advantage of conveying directly whether replacement of the dietary staple with a different food would result in faster or slower blood glucose response. A disadvantage with this system is that the reference food is not well-defined.

A low-GI food will release glucose more slowly and steadily, which leads to more suitable postprandial (after meal) blood glucose readings. A high-GI food causes a more rapid rise in blood glucose levels and is suitable for energy recovery after exercise or for a person experiencing hypoglycemia.

The glycemic effect of foods depends on a number of factors, such as the type of starch (amylose versus amylopectin), physical entrapment of the starch molecules within the food, fat and protein content of the food and organic acids or their salts in the meal—adding vinegar, for example, will lower the GI. The presence of fat or soluble dietary fiber can slow the gastric emptying rate, thus lowering the GI. In general, coarse, grainy breads with higher amounts of fiber have a lower GI value than white breads. However, most breads made with 100% whole wheat or wholemeal flour have a GI not very different from endosperm only (white) bread. Many brown breads are treated with enzymes to soften the crust, which makes the starch more accessible (high GI).

While adding fat or protein will lower the glycemic response to a meal, the relative differences remain. That is, with or without additions, there is still a higher blood glucose curve after a high-GI bread than after a low-GI bread such as pumpernickel.

Fruits and vegetables tend to have a low glycemic index. The glycemic index can be applied only to foods where the test relies on subjects consuming an amount of food containing 50 g of available carbohydrate. But many fruits and vegetables (not potatoes, sweet potatoes, corn) contain less than 50 g of available carbohydrate per typical serving. Carrots were originally and incorrectly reported as having a high GI. Alcoholic beverages have been reported to have low GI values; however, beer was initially reported to have a moderate GI due to the presence of maltose. This has been refuted by brewing industry professionals, who say that all maltose sugar is consumed in the brewing process and that packaged beer has little to no maltose present. Recent studies have shown that the consumption of an alcoholic drink prior to a meal reduces the GI of the meal by approximately 15%. Moderate alcohol consumption more than 12 hours prior to a test does not affect the GI.

Many modern diets rely on the glycemic index, including the South Beach Diet, Transitions by Market America and NutriSystem Nourish Diet. However, others have pointed out that foods generally considered to be unhealthy can have a low glycemic index, for instance, chocolate cake (GI 38), ice cream (37), or pure fructose (19), whereas foods like potatoes and rice have GIs around 100 but are commonly eaten in some countries with low rates of diabetes.

The GI Symbol Program is an independent worldwide GI certification program that helps consumers identify low-GI foods and drinks. The symbol is only on foods or beverages that have had their GI values tested according to standard and meet the GI Foundation's certification criteria as a healthy choice within their food group, so they are also lower in kilojoules, fat and/or salt.

### Weight Control

Recent animal research provides compelling evidence that high-GI carbohydrate is associated with increased risk of obesity. In one study, male rats were split into high- and low-GI groups over 18 weeks while mean body weight was maintained. Rats fed the high-GI diet were 71% fatter and had 8% less lean body mass than the low-GI group. Postmeal glycemia and insulin levels were significantly higher, and plasma triglycerides were threefold greater in the high-GI-fed rats. Furthermore, pancreatic islet cells suffered “severely disorganized architecture and extensive fibrosis.” However, the GI of these diets was not experimentally determined. In a well controlled feeding study no improvement in weight loss was observed with a low glycemic index diet over calorie restriction. Because high-amylose cornstarch (the major component of the assumed low-GI diet) contains large amounts of resistant starch, which is not digested and absorbed as glucose, the lower glycemic response and possibly the beneficial effects can be attributed to lower energy density and fermentation products of the resistant starch, rather than the GI.

In humans, a 2012 study shows that, after weight loss, the energy expenditure is higher on a low-glycemic index diet than on a low-fat diet (but lower than on the Atkins diet). See also news coverage and reactions from other obesity researchers.

### Disease Prevention

Several lines of recent [1999] scientific evidence have shown that individuals who followed a low-GI diet over many years were at a significantly lower risk for developing both type 2 diabetes, coronary heart disease, and age-related macular degeneration than others. High blood glucose levels or repeated glycemic “spikes” following a meal may promote these diseases by increasing systemic glycative stress, other oxidative stress to the vasculature, and also by the direct increase in insulin levels. The glycative stress sets up a vicious cycle of systemic protein glycation, compromised protein editing capacity involving the ubiquitin proteolytic pathway and autophagic pathways, leading to enhanced accumulation of glycated and other obsolete proteins.

In the past, postprandial hyperglycemia has been considered a risk factor associated mainly with diabetes. However, more recent evidence shows that it also presents an increased risk for atherosclerosis in the non-diabetic population and that high GI diets, high blood-sugar levels more generally, and diabetes are related to kidney disease as well.

Conversely, there are areas such as Peru and Asia where people eat high-glycemic index foods such as potatoes and high-GI rice without a high level of obesity or diabetes. The high consumption of legumes in South America and fresh fruit and vegetables in Asia likely lowers the glycemic effect in these individuals. The mixing of high- and low-GI carbohydrates produces moderate GI values.

A study from the University of Sydney in Australia suggests that having a breakfast of white bread and sugar-rich cereals, over time, may make a person susceptible to diabetes, heart disease, and even cancer.

A study published in the American Journal of Clinical Nutrition found that age-related adult macular degeneration (AMD), which leads to blindness, is 42% higher among people with a high-GI diet, and concluded that eating a lower-GI diet would eliminate 20% of AMD cases.

The American Diabetes Association supports glycemic index but warns that the total amount of carbohydrate in the food is still the strongest and most important indicator, and that everyone should make their own custom method that works best for them.

The International Life Sciences Institute concluded in 2011 that because there are many different ways of lowering glycemic response, not all of which have the same effects on health, “It is becoming evident that modifying the glycemic response of the diet should not be seen as a stand-alone strategy but rather as an element of an overall balanced diet and lifestyle.”

A systematic review of few human trials examined the potential of low GI diet to improve pregnancy outcomes. Potential benefits were still seen despite no ground breaking findings in maternal glycemia or pregnancy outcomes. In this regard, more women under low GI diet achieved the target treatment goal for the postprandial glycemic level and reduced their need for insulin treatment. A low GI diet may also provide greater benefits to overweight and obese women. Interestingly, intervention at an early stage of pregnancy has shown a tendency to lower birth weight and birth centile in infants born to women with GDM.

### Other Factors

The number of grams of carbohydrate can have a bigger impact than glycemic index on blood sugar levels, depending on quantities. Consuming fewer calories, losing weight and carbohydrate counting can be better for lowering the blood sugar level. Carbohydrates impact glucose levels most profoundly, and two foods with the same carbohydrate content are, in general, comparable in their effects on blood sugar. A food with a low glycemic index may have a high carbohydrate content or vice versa; this can be accounted for with the glycemic load (GL). Consuming carbohydrates with a low glycemic index and calculating carbohydrate intake would produce the most stable blood sugar levels.

### Criticism and Alternatives

The glycemic index does not take into account other factors besides glycemic response, such as insulin response, which is measured by the insulin index and can be more appropriate in representing the effects from some food contents other than carbohydrates. In particular, since it is based on the area under the curve of the glucose response over time from ingesting a subject food, the shape of the curve has no bearing on the corresponding GI value. The glucose response can rise to a high level and fall quickly, or rise less high but remain there for a longer time, and have the same area under the curve. For subjects with type 1 diabetes who do not have an insulin response, the rate of appearance of glucose after ingestion represents the absorption of the food itself. This glycemic response has been modeled, where the model parameters for the food enable prediction of the continuous effect of the food over time on glucose values, and not merely the ultimate effect that the GI represents.

Although the glycemic index provides some insights into the relative diabetic risk within specific food groups, it contains many counter-intuitive ratings. These include suggestions that bread generally has a higher glycemic ranking than sugar and that some potatoes are more glycemic than glucose. More significantly, studies such as that by Bazzano et al. demonstrate a significant beneficial diabetic effect for fruit compared to a substantial detrimental impact for fruit juice despite these having similar “low GI” ratings.

From blood glucose curves presented by Brand-Miller et al, the main distinguishing feature between average fruit and fruit juice blood glucose curves is the maximum slope of the leading edge of 4.38 mmol·L⁻¹·h⁻¹ for fruit and 6.71 mmol·L¹·h⁻¹ for fruit juice. This raises the concept that the rate of increase in blood glucose may be a significant determinant particularly when comparing liquids to solids which release carbohydrates over time and therefore have an inherently greater area under the blood glucose curve.

It is believed these, the display of the basic nutritional information mandated by governmental regulation and optionally the display of GI (which is rarely displayed), in of themselves do not indicate to the public the over all wholesome quality of the food for its impact on their health.

Hence it is the objective of the embodiments herein to display better or different and improved display of health information on the packaged food items.

It is yet another objective to raise awareness among the public the differences between different food items that is not learnable based on the information currently displayed and mandated by government regulations.

It is yet another objective for the manufacturers to offer for sale more and different food items that are considered healthier then the food items currently being offered.

### SUMMARY

Apparatus and method for visually displaying a new type of health quality indicator (HQI) in the form of a visual graph on an item of food is described. In some embodiments an annotated visual graph on a human food item may be used.

The HQI may be displayed on a package of food item, a restaurant menu item, a recipe for a food item, and a catalogue of nutrition information for various types of food. The food item may be cooked, uncooked and partially cooked. The food item may also be fresh fruits and vegetables such as apple, banana, orange, broccoli, as examples. These food items are or may be packaged with a ribbon that can be used as a package for such items

The HQI is a display of an annotated graph that is visually displayed on a part of the package. The HQI shows the digestion of a food item in an average human over substantially a two and up to four hour time period in the form of change in glucose levels.

A method of determining a health quality indicator (HQI) of a human food item has the steps of: indicating by a HQI a wholesomeness of the food item for effect on the health of a human by determining how it is digested and determining how the food item is digested by determining periodically an average blood glucose level in humans from a base level on ingesting a preset quantity of a food item and plotting the glucose level reading substantially every 15 minutes on a graph for a time period of two to four hours.

The method further has the steps of: analyzing from the graph, a change in glucose levels in sequential four to eight half hour different intervals of time, for a health effect of the food item for determining the health quality of the food item and determining the health quality indicator by comparing the change in glucose levels in these four to eight sequential intervals of time.

The method further has the steps of: adding visual user guidance on the graph, based on an analysis of change in glucose level in these four to eight half hour intervals with an annotation from one of, super healthy, healthy, good and poor and very poor and displaying these annotations on the graph on a packaging of the food item.

These and other aspects of the embodiments herein are further described in detail with the help of the accompanying drawings and the description.

### BRIEF DESCRIPTION OF THE DRAWINGS

Some of the novel features of the embodiments will be best understood from the accompanying drawings, taken in conjunction with the accompanying description, in which similar reference characters refer to similar parts, and in which:

FIGS. 1A and 1B are block diagram that illustrate features of an embodiment of the present invention for package of food item;

FIGS. 2A, 2B, 2C, and 2D are block diagram that illustrate features of an embodiment of the present invention for a restaurant menu, a recipe and a book of nutrition information, and fresh fruits and vegetables;

FIGS. 3A, 3B, 3C, 3D and 3E are block diagram that illustrate features of an embodiment of the present invention for visually displaying health quality of a packaged food item;

FIG. 4 is a diagram that illustrates features of a health quality of a packaged food item.

FIG. 5 is a logic diagram that illustrates features of a health quality of a packaged food item.

FIG. 6 is a method diagram that illustrates features of a health quality of a packaged food item.

FIG. 7 illustrates a PRIOR ART Graph describing the rise of blood sugar after meals.

### DESCRIPTION

Based on a large number of news items, type 2 diabetes is a disease of the endocrinal system of the human body and is a rapidly growing disease for people all over the world. The medical science does not provide a reason for the cause of the disease, other than its effects and how it affects the human body, in the form of insulin resistance and lack of production of insulin by pancreatic organ of the digestive system.

The pharmaceutical industry is actively researching and providing solutions and has provided many and different types of drugs including synthetic insulin that are being used to successfully treat the symptoms of type 2 diabetes.

Medical science believes it is the life style of the people and specifically a sedentary life style of people that is either a sole and or a contributory factor for the onset and progression of this disease. However that fact or observation or data is not born out by the facts as a large number of people suffering from this disease are active people with proper diet and exercise. Failing to attribute the underlying cause of type 2 diabetes to a specific cause, medical professionals, then surmise and states as a fact that the cause is genetic. Given the wide spread of Type 2 diabetes in different types of people, with different life styles and different cultures that alleged statement for cause of diabetes is suspect and cannot be taken as true.

Based on available information, inventor has formed a new or different theory that would explain the spread of this disease of type 2 diabetes among a wide variety of people with different life styles and cultures. Inventor has named this theory as Micro-Shocks to Pancreas (MSP). Based on this MSP theory, the type 2 diabetes condition or disease is caused from a cumulative effect of a very large number of micro-level stresses or shocks on the pancreas.

A food item that creates a spike in the blood glucose level creates a micro-level stress and shock to the functioning of pancreas organ and does micro-level damage to the pancreas.

A large accumulation over time of such micro-level shocks to the pancreas stresses the organ to a point of reduced functioning and eventual failure of the organ. This is much like a large number of micro-level stresses on metal over time would lead to metal fatigue and develop cracks in the metal.

A study that supports this theory is that was done in United Kingdom, where the study showed that a single can of soda consumed once a day by a healthy young adult would increase their chances of getting type 2 diabetes later in life by 25%.

In today's culture and life style, many people consume packaged food items that hide the true effect of the food on the human body and specifically the pancreas. People are not aware of certain aspects of the food and these aspects are not indicated by the available information on the item of packaging. Prior art on the food packaging displays the nutritional information that is mandated by the government regulations as well as ingredients. Even though, knowledge of GI exists, is rarely if ever displayed on a packaging of the food item.

Even if all of these three items of information, nutritional information, ingredients and GI are displayed, these are inadequate and insufficient to address the basic health quality of food.

Unprocessed foods are digested over a period of a few hours and gradually release glucose into the blood system for the pancreas to adjust to this slow rise and produce insulin. Whereas a spike in glucose is abnormal for the pancreas and forces the pancreas to react to this spike and release a large quantity of insulin over a very short period of time.

The lesson from this theory of accumulation of micro-level stresses is perhaps the real and singular underlying cause of the type 2 diabetes, as they are consuming a large number of packaged food items and are not aware of the degree of processing of the underlying ingredients.

An example of that is consumption of white sugar (an extremely refined and processed product) creates a spike in the blood glucose level and a similar spike in blood glucose level is created by white all purpose flour (an extremely refined and processed product from whole grain wheat). Therefore, an awareness of this aspect of the food item would go a long way in making people aware of the rise of glucose level in their blood over time.

The embodiments of this invention create a visual display of the rise of blood glucose over a two to four hour period and such visual displays can be displayed on packages of food items, menus in restaurants, recipes published by others and books on nutritional information of original and processed food items and even fresh foods.

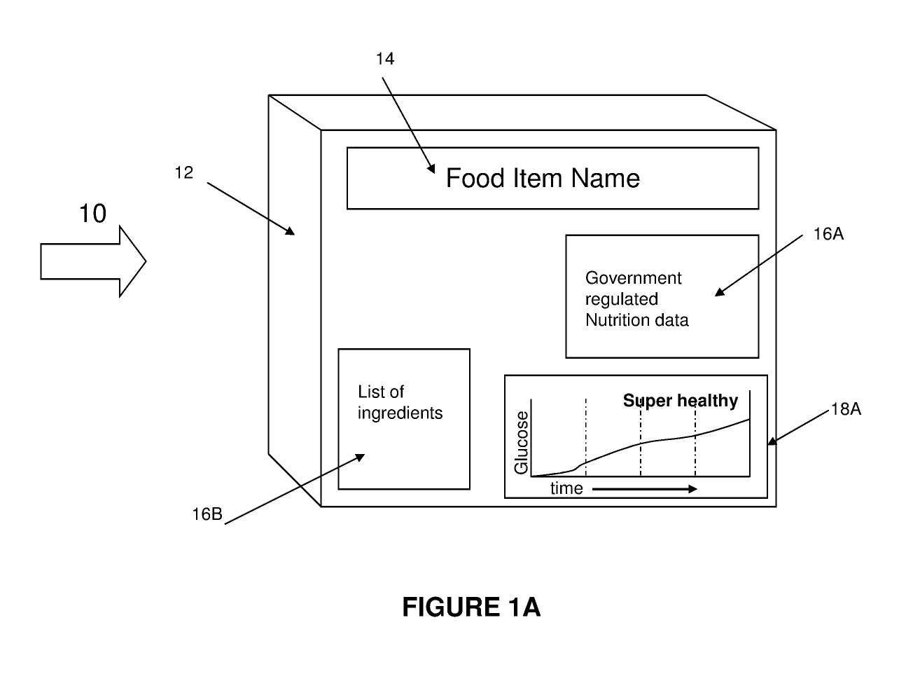

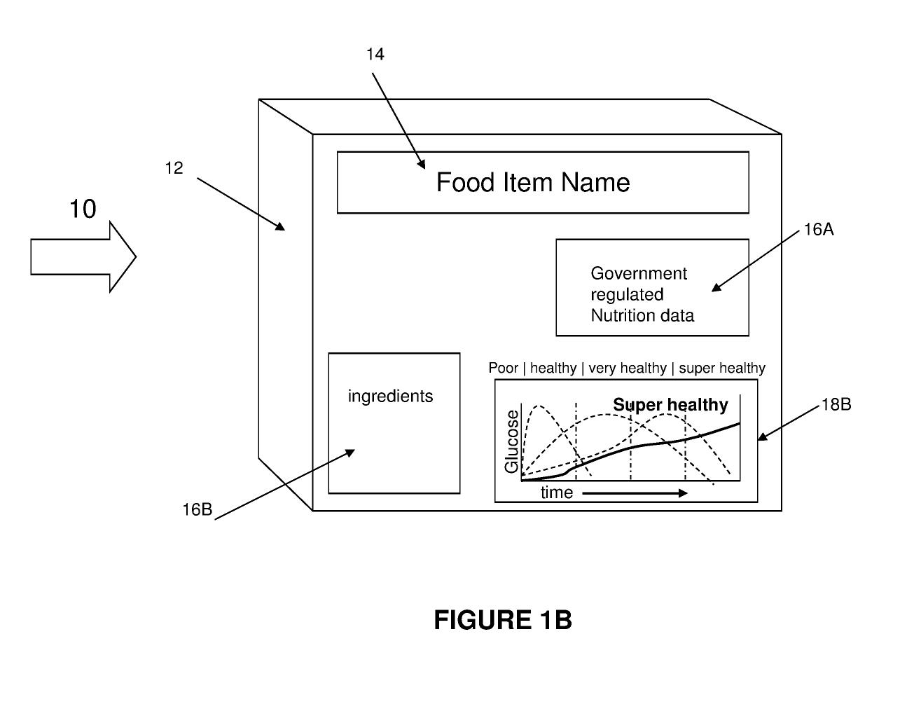

As illustrated with the help of FIGS. 1A and 1B, an apparatus 10 for a health quality indicator (HQI) 18A (FIG. 1A) or 18B (FIG. 1B) of a human food item 14 has a packaging 12 of a food item 14 and a health quality indicator (HQI) 18A or 18B that is displayed on the package 12. On such a package 12, other food information in the form of ingredients 16B and nutritional information 16A is also displayed.

As illustrated in FIG. 1A, the HQI 18A is an annotated graph that is visually displayed on a part of the package and the HQI 18A shows the digestion of a food item in an average human over substantially a two to four hour time period in the form of change in glucose levels.

As illustrated with the help of FIG. 1B, the HQI 18B graph has a display of one of five different health indicators based on change in glucose levels of, super healthy, healthy, good, poor, and very poor.

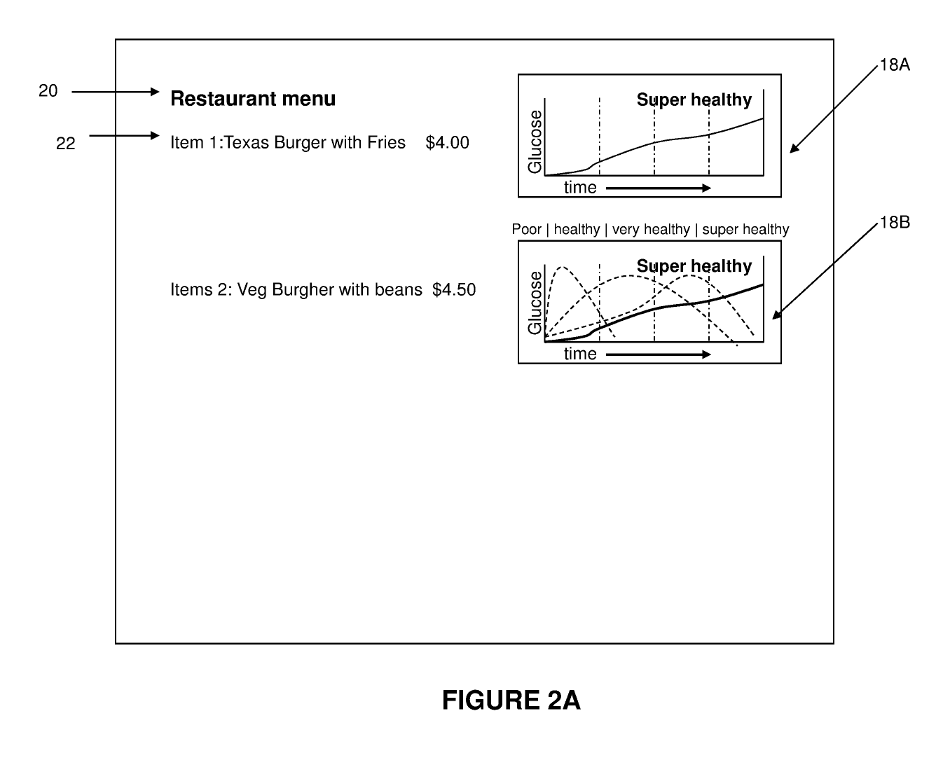

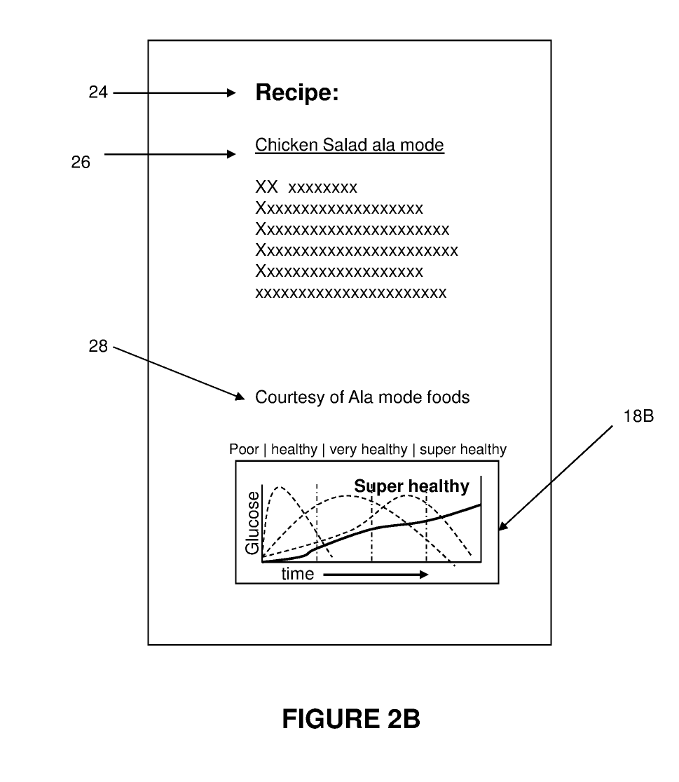

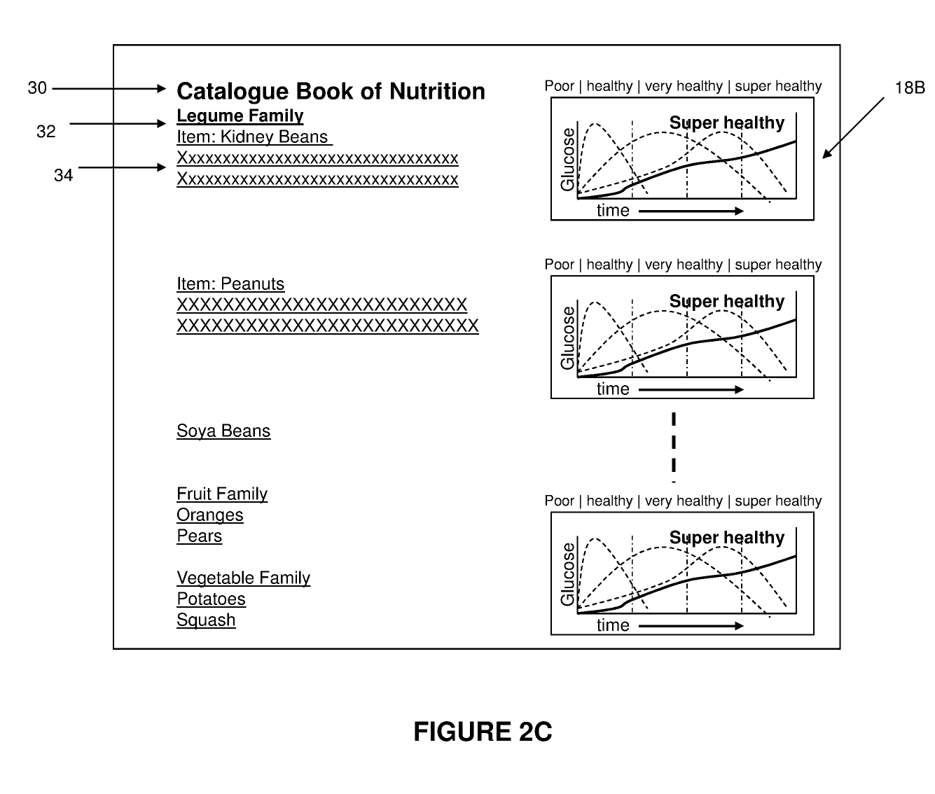

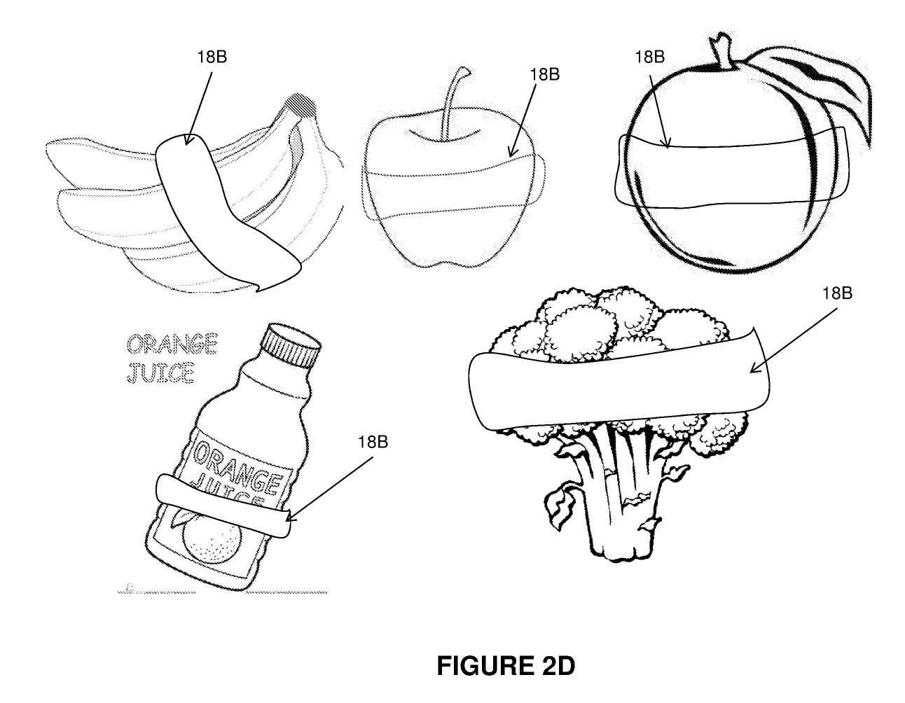

As illustrated with the help of FIG. 2A, the HQI 18 may also be displayed next to food item 22 in a restaurant menu 20. Such a menu and display of HQI 18 would educate the public which item are healthier and also offer the restaurant an incentive to offer more of such healthy items.

As illustrated with the help of FIG. 2B, the HQI 18B may also be displayed next to food item 26 in a published recipe 24. Such a display of HQI 18 would educate the public which items are healthier and also offer an incentive to create more healthy recipes.

As illustrated with the help of FIG. 2C, the HQI 18B may also be displayed next to food item 32 in a book or catalogue 30 of nutritional information 34. Such a catalogue lists many food items including individual raw items, individual cooked items and prepared food items with multiple ingredients. Such a display of HQI 18B would educate the public which items are healthier in their different forms.

As illustrated with the help of FIG. 2D, the HQI 18B may also be displayed on food items such as fresh fruits and vegetables. Such items may come packaged with a ribbon that may be used for displaying HQI 18B. Such a display of HQI 18B would educate the public which items are healthier of the large variety of these food items.

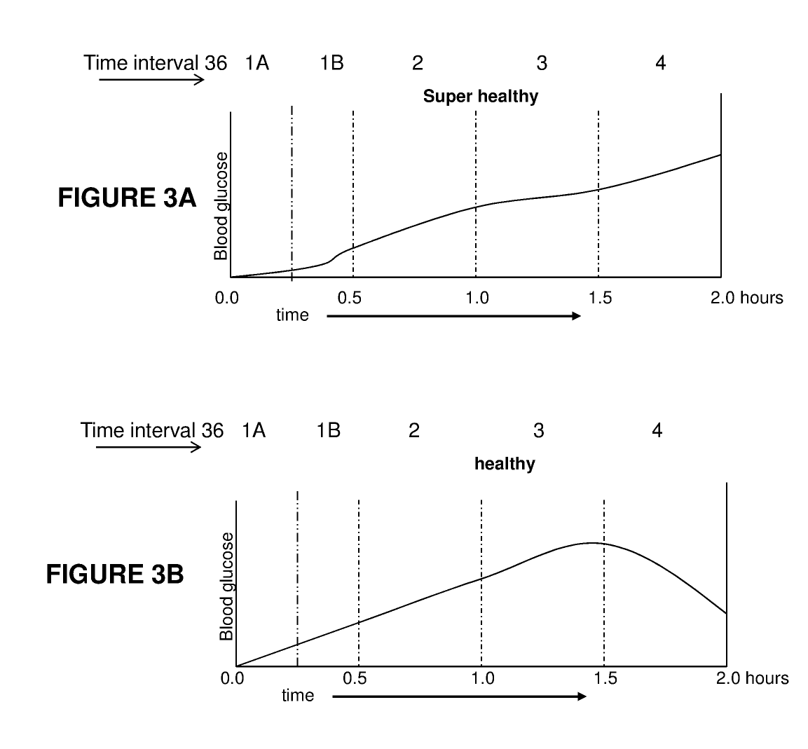

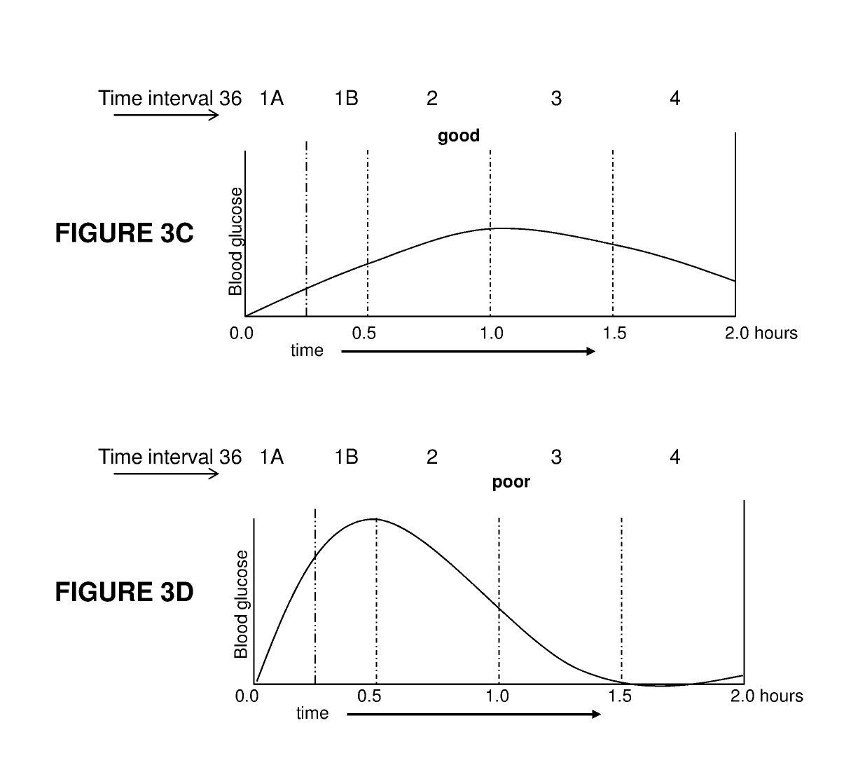

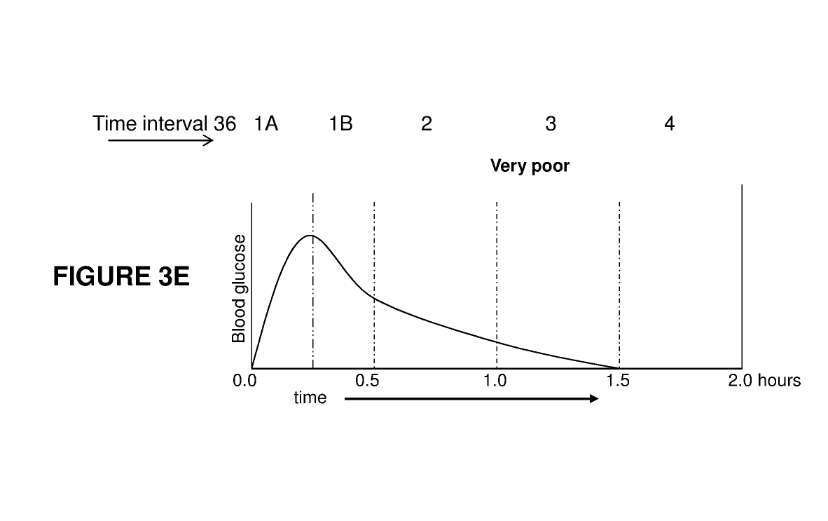

As illustrated with the help of FIG. 3A, the display of super healthy food item is displayed with the help of the visual graph of the rise in blood glucose levels over a period of two hours. The HQI notional of Super Healthy is derived from the shape of the graph. The graph is divided along the time-axis in four intervals of half an hour each. The first interval is further subdivided in two intervals of fifteen minutes each.

FIG. 3A shows a steady rise in glucose level over the two hour time period as the food is digested and is indirectly indicative of food that is healthiest and is indicative of a whole or wholesome or at least a least-processed food item. If the rise in glucose level in interval 4 is greater than interval 3 and interval 3 is greater than interval 2 and interval 2 is greater than interval 1, then the food item may be labeled super healthy, indicative of a slow absorption, indicative of wholesome, whole or least processed food item.

As illustrated with the help of FIG. 3B, the display of Healthy is similarly displayed. If the rise in glucose level in interval 3 is greater than interval 2 and interval 2 is greater than interval 1. This item of food also shows a steady rise over a shorter time period of 1 and half hours.

As illustrated with the help of FIG. 3C, the display of health quality Good is displayed. If the rise in glucose level in interval 2 is greater than interval 1. This item of food also shows a steady rise over a much shorter time period of 1 hour.

As illustrated with the help of FIG. 3D, the display of health quality Poor is displayed, If the rise in glucose level in interval 1B is greater than interval 1A. This item of food crates a spike in the first half an hour and would be creating a jolt or a micro stress on the pancreas.

As illustrated with the help of FIG. 3E, the display of health quality Very Poor is displayed, if the rise in glucose level in interval 1A is greater than interval 1B. This item of food crates a spike in the first fifteen minutes and would be creating a jolt or a micro stress on the pancreas.

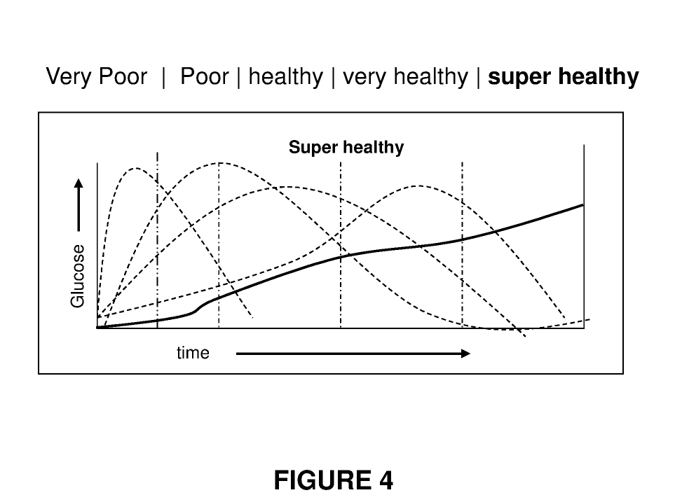

As illustrated with the help of FIG. 4, different health characteristics may be displayed in a single graph 18B, where they are displayed as grayed our or by dotted line, except the graph that is for this specific food item. Also the different types of health are indicated above such as very poor, poor, good, healthy and super healthy.

Other or more suitable legends for these annotations other than these illustrated here may also be used and are not ruled out. It is believed HQI display 18B would educate the public on how to judge the HQI display as well as judge an individual food item.

It should be noted that the four intervals of ½ hour each could be six intervals of 20 minutes each or eight intervals of 15 minutes each. A highly refined food items such as a can of soda beverage, white sugar, white flour, and fruit juice would create a spike in the first 10 minutes to 20 minutes or even sooner. Hence to distinguish such food items, the first half an hour interval may be divided in three intervals of 10 minutes each. This would help identify a super unhealthy item or very poor, where the rise and fall of the spike occurs in the first half an hour or first ten to fifteen minutes.

The size of HQI 18A or 18B display is a function of the package size or available space, however, a size of approximately ½″ to 1″ in height and width of 1.0 inch to 3 inches may be adequate to visually alert and educate the public about the health quality of food they are about to consume.

Most food that is consumed is likely a combination of carbohydrates of different types, fat and protein, where each of these parts of the food each would have a different graph of blood sugar rise, however, people want to relate to the overall effect of consuming the food. This would raise awareness to the public of both the combined effect as well as the individual parts of the food.

As a simplified illustration, it should be noted that representations of graphs in FIGS. 3A to 3E and other figures as well are simplified representations of the effect of food on the body and blood glucose level and are not actual data driven graphs.

Further it should be noted to collect actual and realistic data for the graphs presents some problems. First of these problems is that in a healthy adult, as soon as the pancreas determines from the blood a rising above a threshold glucose level, it starts releasing insulin to the blood stream that acts to quickly lower the glucose level.

So no matter what type of food and how slowly or fast it releases glucose in the blood, a counter veiling effect of pancreas releasing insulin would very quickly change the graph. That is the graph would be a rise and then fall and then rise and then fall indicative of operation of pancreas as the food is digested over time.

To over come this issue of data collection, there are two approaches, the first is that test subject be selected from Type 1 diabetes people. Alternatively the data be collected from type 2 diabetes people in late stage where they take insulin and their pancreas is not functioning.

Yet alternatively, in any of these approaches to data collection, the quantity of food be such a low amount that the data can be collected before the action of the pancreas kicks in. It is believed, the pancreas kicks in at about 150 to 180 blood glucose level. So if the quantity of food is limited to an ounce, it would show the rise of glucose and it is believed the pancreas would not have kicked in. There may be other approaches to data collection and they are not ruled out. Others may have done such data collection for the glucemic index, as has been described in the background section and these approaches may also be used

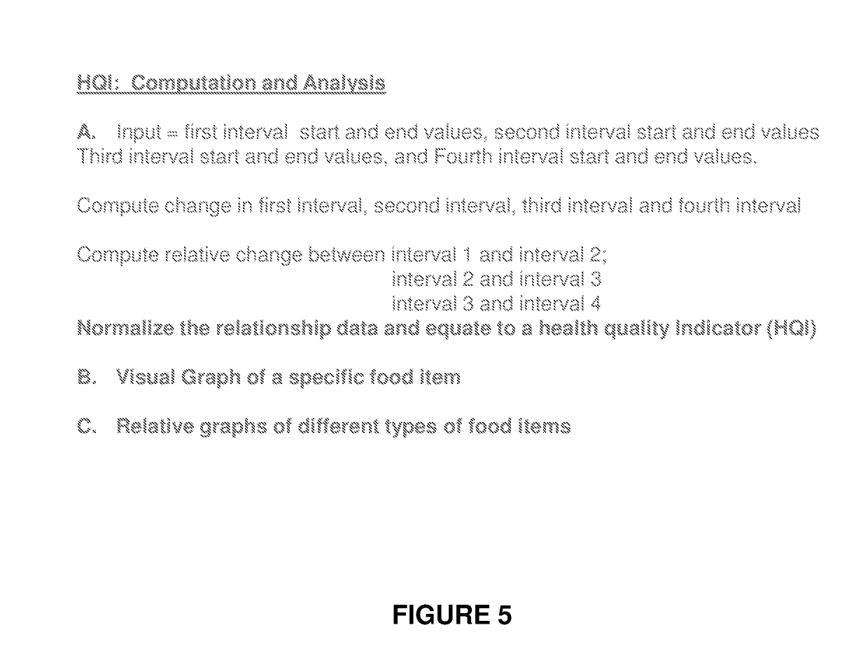

FIG. 5 provides a simplified illustration on how the graph data may be analyzed and categorized into different health effects. In reality, there are three different visual indications in HQI 18, one is the graph itself for a particular food item, second is the graph of food items that represent different health effects and these are shown as grayed out and the third is analysis of the graph in five different types of foods from super bad, bad, good, healthy and super healthy.

The cumulative effect of these three aspects of HQI, not only would, it is believed, educate people but visually, psychologically and mentally communicate to then on how to judge the health quality of food.

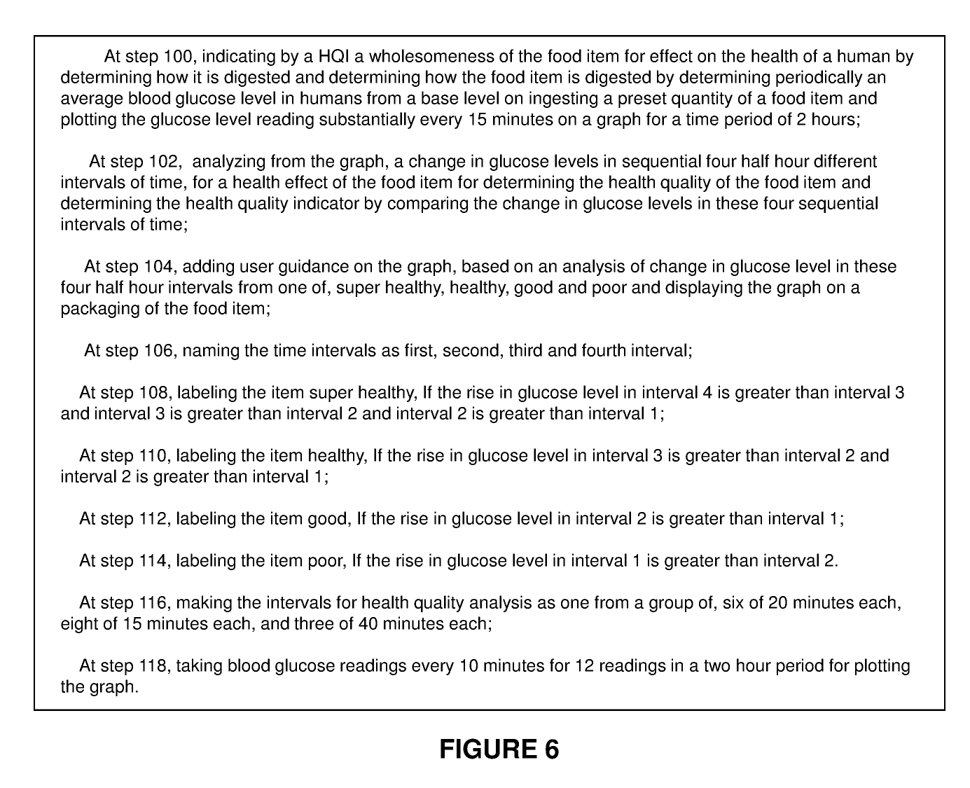

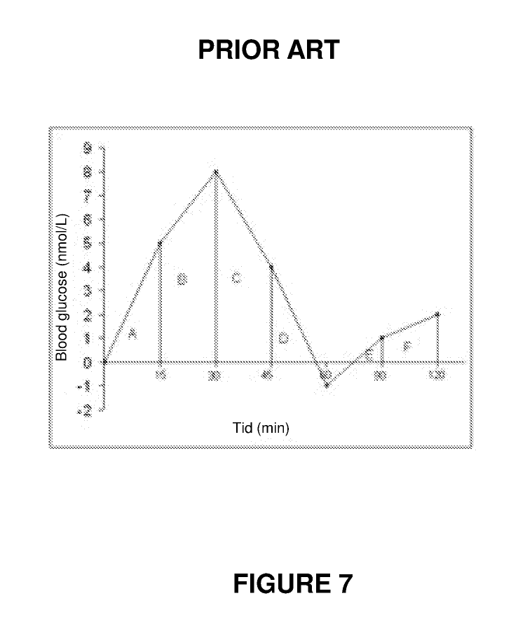

FIG. 6 illustrates a method, where all the steps may not be used or used in the order specified.

At step 100, indicating by a HQI a wholesomeness of the food item for effect on the health of a human by determining how it is digested and determining how the food item is digested by determining periodically an average blood glucose level in humans from a base level on ingesting a preset quantity of a food item and plotting the glucose level reading substantially every 15 minutes on a graph for a time period of 2 hours;

At step 102, analyzing from the graph, a change in glucose levels in sequential four half hour different intervals of time, for a health effect of the food item for determining the health quality of the food item and determining the health quality indicator by comparing the change in glucose levels in these four sequential intervals of time;

At step 104, adding user guidance on the graph, based on an analysis of change in glucose level in these four half hour intervals from one of, super healthy, healthy, good and poor and displaying the graph on a packaging of the food item;

At step 106, naming the time intervals as first, second, third and fourth interval;

At step 108, labeling the item super healthy, if the rise in glucose level in interval 4 is greater than interval 3 and interval 3 is greater than interval 2 and interval 2 is greater than interval 1;

At step 110, labeling the item healthy, if the rise in glucose level in interval 3 is greater than interval 2 and interval 2 is greater than interval 1;

At step 112, labeling the item good, if the rise in glucose level in interval 2 is greater than interval 1;

At step 114, labeling the item poor, if the rise in glucose level in interval 1 is greater than interval 2.

At step 116, making the intervals for health quality analysis as one from a group of, six of 20 minutes each, eight of 15 minutes each, and three of 40 minutes each;

At step 118, taking blood glucose readings every 10 minutes for 12 readings in a two hour period for plotting the graph.

An apparatus for a health quality indicator (HQI) of a human food item has a packaging of a food item and a health quality indicator (HQI) that is displayed on the packaging. The HQI is an annotated graph with multiple time intervals that is visually displayed on a part of the packaging, and the HQI shows the digestion of the food item in an average human over substantially a two to four hour time period in the form of change in glucose levels.

The annotated graph has multiple time intervals of half an hour, each marked as interval 1, 2, 3 and 4 and interval 1 is further marked as interval 1A and 1B for 15 minute intervals. The annotated graph has a display of one of five different health indicator legends based on change in glucose levels of, super healthy, very healthy, good, poor, and very poor.

The display of legend “super healthy” is displayed if the rise in glucose level in an interval 4 is greater than interval 3 and interval 3 is greater than interval 2 and interval 2 is greater than interval 1. The display of legend “very healthy” is displayed, if the rise in glucose level in interval 3 is greater than interval 2 and interval 2 is greater than interval 1. The display of legend “good” is displayed, if the rise in glucose level in interval 2 is greater than interval 1. The display of legend “poor” is displayed, if the rise in glucose level in interval 1 is greater than interval 2. The display of legend “very poor” is displayed, if the rise in glucose level in interval 1A is greater than interval 1B.

The food item is a fresh fruit, where the packaging is a ribbon or label. The food item is a fresh vegetable, where the packaging is a ribbon or label.

A method for a health quality indicator (HQI) of a human food item, comprising the steps of, where all the steps may not be used or used in the order provided:

a. providing a packaging of a food item and a health quality indicator (HQI) that is displayed on the packaging;

b. providing on the packaging the HQI an annotated graph with multiple time intervals that is visually displayed on a part of the packaging; and

c. illustrating by the HQI the digestion of the food item in an average human over substantially a two to four hour time period in the form of change in glucose levels;

d. providing in the annotated graph multiple time intervals of half an hour, each marked as interval 1, 2, 3 and 4 and interval 1 is further marked as interval 1A and 1B for 15 minute intervals;

e. displaying by the annotated graph one of five different health indicator legends based on change in glucose levels of, super healthy, very healthy, good, poor, and very poor;

f. displaying a legend “super healthy” if the rise in glucose level in an interval 4 is greater than interval 3 and interval 3 is greater than interval 2 and interval 2 is greater than interval 1;

g. displaying of a legend “very healthy”, If the rise in glucose level in interval 3 is greater than interval 2 and interval 2 is greater than interval 1;

h. displaying of a legend “good”, If the rise in glucose level in interval 2 is greater than interval 1;

i. displaying of a legend “poor”, If the rise in glucose level in interval 1 is greater than interval 2;

j. displaying of a legend “very poor”, If the rise in glucose level in interval 1A is greater than interval 1B;

k. providing the food item is a fresh fruit or fresh vegetable, where the packaging is a ribbon or label.

A method of determining a health quality indicator (HQI) of a human food item, comprising the steps of, where all the steps may not be used or used in the order specified:

a. indicating by a HQI a wholesomeness of the food item for effect on the health of a human by determining how it is digested and determining how the food item is digested by determining periodically an average blood glucose level in humans from a base level on ingesting a preset quantity of a food item and plotting the glucose level reading substantially every 15 minutes on a graph for a time period of 2 hours;

b. analyzing from the graph, a change in glucose levels in sequential four half hour different intervals of time, for a health effect of the food item for determining the health quality of the food item and determining the health quality indicator by comparing the change in glucose levels in these four sequential intervals of time;

c. adding user guidance on the graph, based on an analysis of change in glucose level in these four half hour intervals from one of, super healthy, healthy, good and poor and displaying the graph on a packaging of the food item; d. naming the time intervals as first, second, third and fourth interval;

e. labeling the item super healthy, If the rise in glucose level in interval 4 is greater than interval 3 and interval 3 is greater than interval 2 and interval 2 is greater than interval 1;

f. labeling the item healthy, If the rise in glucose level in interval 3 is greater than interval 2 and interval 2 is greater than interval 1;

g. labeling the item good, If the rise in glucose level in interval 2 is greater than interval 1;

h. labeling the item poor, If the rise in glucose level in interval 1 is greater than interval 2;

i. making the intervals for health quality analysis as one from a group of, six of 20 minutes each, eight of 15 minutes each, and three of 40 minutes each;

j. taking blood glucose readings every 10 minutes for 12 readings in a two hour period for plotting the graph.

While the particular invention, as illustrated herein and disclosed in detail is fully capable of obtaining the objective and providing the advantages herein before stated, it is to be understood that it is merely illustrative of the presently preferred embodiments of the invention and that no limitations are intended to the details of construction or design herein shown other than as described in the appended claims.

1. An apparatus for a health quality indicator (HQI) of a human food item, comprising:
a. a packaging of a food item and a health quality indicator (HQI) that is displayed on the packaging;
b. the HQI is an annotated graph with multiple time intervals that is visually displayed on a part of the packaging; and
c. the HQI shows the digestion of the food item in an average human over substantially a two to four hour time period in the form of change in glucose levels.

2. The apparatus as in claim 1, comprising:
the annotated graph has multiple time intervals of half an hour, each marked as interval 1, 2, 3 and 4 and interval 1 is further marked as interval 1A and 1B for 15 minute intervals;
the annotated graph has a display of one of five different health indicator legends based on change in glucose levels of, super healthy, very healthy, good, poor, and very poor.

3. The apparatus as in claim 2, comprising:
the display of legend “super healthy” is displayed If the rise in glucose level in an interval 4 is greater than interval 3 and interval 3 is greater than interval 2 and interval 2 is greater than interval 1.

4. The apparatus as in claim 2, comprising:
the display of legend “very healthy” is displayed, If the rise in glucose level in interval 3 is greater than interval 2 and interval 2 is greater than interval 1.

5. The apparatus as in claim 2, comprising:
the display of legend “good” is displayed, If the rise in glucose level in interval 2 is greater than interval 1.

6. The apparatus as in claim 2, comprising:
the display of legend “poor” is displayed, If the rise in glucose level in interval 1 is greater than interval 2.

7. The apparatus as in claim 2, comprising:
the display of legend “very poor” is displayed, If the rise in glucose level in interval 1A is greater than interval 1B.

8. The apparatus as in claim 1, comprising:
the food item is a fresh fruit, where the packaging is a ribbon or label.

9. The apparatus as in claim 1, comprising:
the food item is a fresh vegetable, where the packaging is a ribbon or label.

10. A method for a health quality indicator (HQI) of a human food item, comprising the steps of:
a. providing a packaging of a food item and a health quality indicator (HQI) that is displayed on the packaging;
b. providing on the packaging the HQI an annotated graph with multiple time intervals that is visually displayed on a part of the packaging; and
c. illustrating by the HQI the digestion of the food item in an average human over substantially a two to four hour time period in the form of change in glucose levels.

11. The method as in claim 10, comprising the steps of:
providing in the annotated graph multiple time intervals of half an hour, each marked as interval 1, 2, 3 and 4 and interval 1 is further marked as interval 1A and 1B for 15 minute intervals;
displaying by the annotated graph one of five different health indicator legends based on change in glucose levels of, super healthy, very healthy, good, poor, and very poor.

12. The method as in claim 11, comprising the steps of:
displaying a legend “super healthy” if the rise in glucose level in an interval 4 is greater than interval 3 and interval 3 is greater than interval 2 and interval 2 is greater than interval 1.

13. The method as in claim 11, comprising the steps of:
displaying of a legend “very healthy”, If the rise in glucose level in interval 3 is greater than interval 2 and interval 2 is greater than interval 1.

14. The method as in claim 11, comprising the steps of:
displaying of a legend “good”, If the rise in glucose level in interval 2 is greater than interval 1.

15. The method as in claim 11, comprising the steps of:
displaying of a legend “poor”, If the rise in glucose level in interval 1 is greater than interval 2.

16. The method as in claim 11, comprising the steps of:
displaying of a legend “very poor”, If the rise in glucose level in interval 1A is greater than interval 1B.

16. The method as in claim 10, comprising the steps of:
providing the food item is a fresh fruit or fresh vegetable, where the packaging is a ribbon or label.

17. A method of determining a health quality indicator (HQI) of a human food item, comprising the steps of:
a. indicating by a HQI a wholesomeness of the food item for effect on the health of a human by determining how it is digested and determining how the food item is digested by determining periodically an average blood glucose level in humans from a base level on ingesting a preset quantity of a food item and plotting the glucose level reading substantially every 15 minutes on a graph for a time period of 2 hours;
b. analyzing from the graph, a change in glucose levels in sequential four half hour different intervals of time, for a health effect of the food item for determining the health quality of the food item and determining the health quality indicator by comparing the change in glucose levels in these four sequential intervals of time;
c. adding user guidance on the graph, based on an analysis of change in glucose level in these four half hour intervals from one of, super healthy, healthy, good and poor and displaying the graph on a packaging of the food item.

18. The method as in claim 17, comprising the steps of:
naming the time intervals as first, second, third and fourth interval;
labeling the item super healthy, If the rise in glucose level in interval 4 is greater than interval 3 and interval 3 is greater than interval 2 and interval 2 is greater than interval 1;
labeling the item healthy, If the rise in glucose level in interval 3 is greater than interval 2 and interval 2 is greater than interval 1;
labeling the item good, If the rise in glucose level in interval 2 is greater than interval 1;
labeling the item poor, If the rise in glucose level in interval 1 is greater than interval 2.

19. The method as in claim 17, comprising the steps of:
a. making the intervals for health quality analysis as one from a group of, six of 20 minutes each, eight of 15 minutes each, and three of 40 minutes each;
b. taking blood glucose readings every 10 minutes for 12 readings in a two hour period for plotting the graph.
